(19) United States
(12) Patent Application Publication
(10) Pub. No.: US 2013/0209905 A1
(43) Pub. Date: Aug. 15, 2013

(54) PROCESS FOR THE PRODUCTION OF HYDROGEN

(71) Applicants: Andrew Phillips, Dublin (IE); Dominique Schreiber, Dublin (IE)

(72) Inventors: Andrew Phillips, Dublin (IE); Dominique Schreiber, Dublin (IE)

(73) Assignee: NOVAUCD, Dublin (IE)

(21) Appl. No.: 13/701,275

(22) PCT Filed: May 31, 2011
(86) PCT No.: PCT/IB11/52403

§ 371 Date: Apr. 22, 2013

(30) Foreign Application Priority Data
Jun. 1, 2010 (GB) 1009172.6

(51) Int. Cl. C01B 3/06; H01M 8/06; B01J 31/22

(52) U.S. Cl. CPC C01B 3/06; B01J 31/2295; H01M 8/0606
USPC 429/421; 423/648.1; 556/137

(57) ABSTRACT

The present invention relates to a process for the production of hydrogen comprising contacting at least one complex of formula (I), wherein: X⁻ is an anion; Y is N or CR⁶; M is selected from Ru, Os and Fe; each of A and B is independently a saturated, unsaturated or partially unsaturated carbocyclic ring; R⁵, R⁶ and R⁷ are each independently selected from H, NR24R25, C₁₋₆-alkyl and C₁₋₆-haloalkyl, or two or more of R⁵, R⁶ and R⁷ are linked, together with the carbons to which they are attached, to form a saturated or unsaturated carbocyclic group; R⁸-R²⁵ are each independently selected from H, C₁₋₆-alkyl, C₁₋₆-haloalkyl and a linker group optionally attached to a solid support; with at least one substrate of formula (II), R¹R²—NH—BH—R³R⁴ (II), wherein R¹, R², R³ and R⁴ are each independently selected from H, C₁₋₂₀-alkyl, fluoro-substituted-C₁₋₂₀-alkyl and C₆₋₁₄-aryl, or any two of R¹, R², R³ and R⁴ are linked to form a C₂₋₁₀-alkylene group, which together with the nitrogen and/or boron atoms to which they are attached, forms a cyclic group. Further aspects of the invention relate to a hydrogen generation system comprising a complex of formula (I), a substrate of formula (II) and a solvent, and to the use of complexes of formula (I) in fuel cells. Another aspect of the invention relates to novel complexes of formula (I).

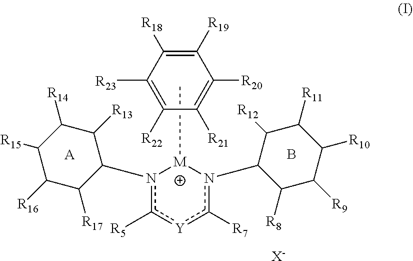

The present invention relates to a process for the production of dihydrogen. More specifically, the invention relates to a process for catalysing the release of dihydrogen from ammonia borane, and derivatives thereof, using a transition metal catalyst. The process of the invention has important applications in the field of hydrogen fuel cells.

### BACKGROUND TO THE INVENTION

The combustion of hydrogen and oxygen is regarded as the cleanest possible source of energy, with water as the only product. Scientific agencies across the globe have clearly stated the need for the safe storage of hydrogen, which at high pressure is extremely explosive. In order to secure practical useable amounts of hydrogen, reinforced heavy steel walled pressurized gas tanks are required. In transportation applications, this leads to a significant waste of energy in carrying the extra weight required for the hydrogen cylinder. Moreover, the refilling of pressurized hydrogen represents a significant hazard.

One way of solving the problem of safe transportation is to use chemical hydrides as an alternative source of releasable hydrogen. Chemical hydrides can be packaged as non-pyrophoric, non-hazardous, solid, slurried or liquid fuels. Hydrogen may then be generated on demand from the chemical hydride under controlled conditions. Ideally, hydrogen storage materials have a high hydrogen content and a low molecular weight. One such example is ammonia borane, H₃N—BH₃, which has a very high hydrogen content by weight (19.2%) and is attracting attention as a means of achieving efficient chemical hydrogen storage.

Although the cost of ammonia borane is still high compared to other hydrides, substantial research efforts are directed to finding new methods of synthesis. A number of low energy (i.e. minimal heat input) methods for obtaining large amounts of hydrogen from ammonia borane are documented in the art. For example, Manners et al reported that precious metal Rh, Ir, Pd and Ru catalysts are active for amine-borane dehydrocoupling at room temperatures with catalyst loadings as low as 0.5 mol % (J. Am. Chem. Soc., 2003, 125, 9424-9434). Examples of suitable catalyst include [Rh(1,5-cod)(μ-Cl)]₂, [Ir(1,5-cod)(μ-Cl)]₂, RhCl₃, IrCl₃, trans-RuMe₂(PMe₃)₄ and trans-PdCl₂(P(o-tolyl)₃)₂. Similarly, secondary amine-borane adducts, R₂NH—BH₃, have also been shown to undergo catalytic dehydrocoupling in the presence of Rh(I) or Rh (II) complexes to form cyclic aminoboranes and borazines (Manners et al, Chem. Commun., 2001, 962-963).

Baker et al discloses base metal catalysed dehydrogenation of ammonia borane using a nickel catalyst (J. Am. Chem. Soc., 2007, 129, 1844-1845). Similarly, Fagnou et al (J. Am. Chem. Soc., 2008, 103, 14034-14035) disclose ruthenium catalysts containing mixed phosphorus and nitrogen-containing ligands and their use in the dehydrogenation of ammonia boranes.

US 2009274613 (Hamilton et al) discloses the production of hydrogen from ammonia borane using a catalyst complex of the formula Lₙ-M-X, where M is a base metal such as Fe, Mn, Co, Ni and Cu, X is an anionic nitrogen- or phosphorus-based ligand or hydride, and L is a neutral ancillary ligand that is a neutral monodentate or polydentate ligand.

U.S. Pat. No. 7,544,837 (Blacquiere et al) describes a method of dehydrogenating an amine-borane of formula R¹H₂N—BH₂R² using a base metal catalyst, to generate hydrogen and at least one of a [R¹HN—BHR²]ₘ oligomer and a [R¹N—BR²]ₙ oligomer. Base metal catalysts are defined as transition metals other than Pt, Pd, Rh, Os and Ru. The method has applications in the field of fuel cells.

The use of ligand stabilized homogenous catalysts containing Ru, Co, Ir, Ni and Pd to catalyse the release of hydrogen from ammonia borane is also described in WO 2008141439 (Kanata Chemical Technologies Inc.). Suitable ligands include phosphines, aminophosphines, heterocyclic ligands, diaminophosphines, diamines, thiophines and thioamines.

US 20080159949 (Mohajeri et al) discloses a method of generating hydrogen from an ammonia borane complex using catalysts including cobalt complexes, noble metal complexes and metallocenes. Examples of suitable noble metal catalysts include NaRhCl₆, chlorotris(triphenylphosphine) Rh (I), (NH₄)₂RuCl₆K₂PtCl₆, (NH₄)₂PtCl₆Na₂PtCl₆, H₂PtCl₆, Fe(C₅H₅)₂ and di-p-chlorobis(p-cymene)chororuthenium. The method is suitable for use in polymer electrolyte membrane fuel cells (also known as proton exchange or PEMFCs).

Over recent years, significant effort has been put into developing new hydrogen storage methods. However, all of the methods reported to date feature a number of potential drawbacks which potentially limit their commercial applications. Although the release of hydrogen from ammonia borane is catalyzed by a wide range of metal complexes, there are several potential issues that limit commercial application. The first is the high cost associated with the iridium or rhodium metal catalysts reported to date. The second problem is sensitivity to atmospheric oxygen, which at low levels significantly deactivates iridium and rhodium-based systems. Thus, it would be advantageous to develop a catalyst which shows a higher degree of tolerance to atmospheric oxygen.

More importantly, the majority of homogenous metal-based dehydrogen catalytic complexes developed to date tend to operate and produce high pressures even at the storage stage. This leads to potential safety hazards which necessitate the use of reaction containers that are able to withstand significantly higher pressures. Synthesis and further adaptation of the ligand system is difficult and requires multiple steps with costly separations.

Finally, reversibility through regeneration back to original ammonia borane is not feasible with many of the single site metal catalysts reported to date. Furthermore, these single site catalysis do not process the ability to switch off at low hydrogen pressure, thereby creating potentially dangerous pressures, especially in situations where the cell is exposed to elevated temperatures.

The present invention seeks to provide a new method of generating hydrogen that alleviates one or more of the above problems. Specifically, the invention seeks to provide a means for storing hydrogen that allows for the controlled and safe release of dihydrogen at a constant rate.

### STATEMENT OF INVENTION

The present invention broadly relates to a process for the catalytic dihydrogen decoupling of ammonia boranes and derivatives thereof.

More specifically, a first aspect of the invention relates to a process for the production of dihydrogen comprising contacting at least one complex of formula (I),

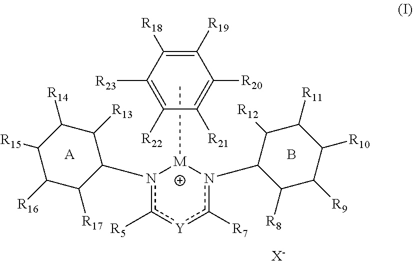

wherein:
X⁻ is an anion;

### Y is N or CR⁶;

M is selected from Ru, Os and Fe;
each of A and B is independently a saturated, unsaturated or partially unsaturated carbocyclic ring;
R⁵, R⁶ and R⁷ are each independently selected from H, NR²⁴R²⁵, C₁₋₆-alkyl and C₁₋₆-haloalkyl, or two or more of R⁵, R⁶ and R⁷ are linked, together with the carbons to which they are attached, to form a saturated or unsaturated carbocyclic group;
R⁸-R²⁵ are each independently selected from H, C₁₋₆-alkyl, C₁₋₆-haloalkyl and a linker group optionally attached to a solid support; with at least one substrate of formula (II),

R¹R²—NH—BH—R³R⁴ (II)

wherein R¹, R², R³ and R⁴ are each independently selected from H, C₁₋₂₀-alkyl, fluoro-substituted-C₁₋₂₀-alkyl, and C₆₋₁₄-aryl, or any two of R¹, R², R³ and R⁴ are linked to form a C₂₋₁₀-alkylene group, which together with the nitrogen and/or boron atoms to which they are attached, forms a cyclic group.

Advantageously, the presently described process provides a homogenous catalyst that activates gaseous dihydrogen. Ab initio calculations and experimental evidence have shown that a bifunctional mechanism is operative for the decoupling of ammonia borane.

Preliminary studies have also indicated that at elevated pressure and temperature the process is reversible. Thus, the unique dual site design of the β-diketiminato-metal complex offers the possibility for reversible H₂ coupling, thereby regenerating the original ammonia borane and eliminating the need for external removal and reloading of the energy storage medium.

A second aspect of the invention relates to a hydrogen generation system comprising:

(a) at least one complex of formula (I)

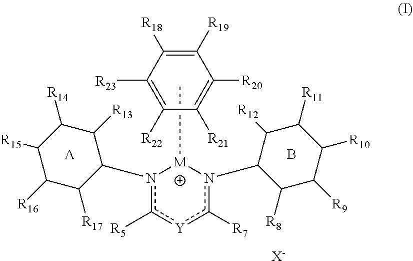

wherein:
X⁻ is an anion;

### Y is N or CR⁶

M is selected from Ru, Os and Fe;
each of A and B is independently a saturated, unsaturated or partially unsaturated carbocyclic ring;
R⁵, R⁶ and R⁷ are each independently selected from H, NR²⁴R²⁵, C₁₋₆-alkyl and C₁₋₆-haloalkyl, or two or more of R⁵, R⁶ and R⁷ are linked, together with the carbons to which they are attached, to form a saturated or unsaturated carbocyclic group;
R⁸-R²⁵ are each independently selected from H, C₁₋₅-alkyl, C₁₋₆-haloalkyl and a linker group optionally attached to a solid support;
(b) at least one substrate of formula (II),

R¹R²—NH—BH—R³R⁴ (II)

wherein R¹, R², R³ and R⁴ are each independently selected from H, fluoro-substituted-C₁₋₂₀-alkyl and C₆₋₁₄-aryl, or any two of R¹, R², R³ and R⁴ are linked to form a C₂₋₁₀-alkylene group, which together with the nitrogen and/or boron atoms to which they are attached, forms a cyclic group; and
(c) a solvent.

A third aspect of the invention relates to the use of at least one complex of formula (I) as defined above in a fuel cell.

A fourth aspect of the invention relates to a fuel cell comprising at least one complex of formula (I) as defined above.

A fifth aspect of the invention relates to a method of thermolytically dehydrogenating a substrate of formula (II) as described above, said method comprising contacting at least one substrate of formula (II) with a complex of formula (I) in the presence of a solvent.

A sixth aspect of the invention relates to the use of at least one complex of formula (I) as defined above in a method of thermolytically dehydrogenating a substrate of formula (II) as described above.

A seventh aspect of the invention relates to the use of at least one complex of formula (I) as defined above in a method of producing hydrogen.

An eighth aspect of the invention relates to complexes of formula (I).

A ninth aspect of the invention relates to a method of using a hydrogen generation system as defined above which comprises modulating the hydrogen pressure in said system so as to modulate activity of the at least one complex of formula (I).

### DETAILED DESCRIPTION

As used herein, the term “C₁₋ₙalkyl” means straight or branched chain, saturated alkyl groups containing from one to n carbon atoms and includes (depending on the identity of n) methyl, ethyl, propyl, isopropyl, n-butyl, s-butyl, isobutyl, t-butyl, 2,2-dimethylbutyl, n-pentyl, 2-methylpentyl, 3-methylpentyl, 4-methylpentyl, n-hexyl and the like, where the variable n is an integer representing the largest number of carbon atoms in the alkyl group. In one preferred embodiment, the C₁₋ₙalkyl group is a C₁₋₂₀-alkyl group, more preferably a C₁₋₆-alkyl group.

As used herein, the term “C₁₋ₙ-haloalkyl” refers to a C₁₋ₙ-alkyl group as defined above in which one or more hydrogens are replaced with a halogen atom selected from Br, F, Cl and I. Preferably, the C₁₋ₙ-haloalkyl group is a C₁₋₂₀-haloalkyl group, more preferably a C₁₋₁₀-haloalkyl group, even more preferably, a C₁₋₆-haloalkyl group. In one particularly preferred embodiment, the C₁₋ₙ-haloalkyl group is a C₁₋ₙ-fluoroalkyl group, more preferably, a C₁₋₂₀-fluoroalkyl group, even more preferably a C₁₋₁₀-fluoroalkyl group, even more preferably still, a C₁₋₆-fluoroalkyl group. CF₃ is a particularly preferred C₁₋₆-fluoroalkyl group.

As used herein, the term “C₆₋ₙaryl” means a monocyclic, bicyclic or tricyclic carbocyclic ring system containing from 6 to n carbon atoms and at least one aromatic ring and includes, depending on the identity of n, phenyl, naphthyl, anthracenyl, 1,2-dihydronaphthyl, 1,2,3,4-tetrahydronaphthyl, fluorenyl, indanyl, indenyl and the like, where the variable n is an integer representing the largest number of carbon atoms in the aryl group. In one preferred embodiment, the C₆₋ₙaryl group is a C₆₋₁₄-aryl group, more preferably, a C₆₋₁₀-aryl group, even more preferably, a phenyl group.

As used herein, the term “aralkyl” means a conjunction of C₁₋ₙalkyl or C₁₋ₙ-haloalkyl and C₆₋ₙaryl as defined above. Preferred aralklyl groups include benzyl.

As used herein, the term “carbocyclic group” means a carbon-containing ring system, that includes monocycles, fused bicyclic and polycyclic rings, bridged rings and metallocenes. Where specified, the carbons in the rings may be substituted or replaced with heteroatoms. Preferably, the carbocyclic group is cyclohexyl.

In one highly preferred embodiment, each of A and B is independently an unsaturated carbocyclic ring, more preferably a phenyl ring. Carbocyclic ring A is substituted by groups R⁸-R¹² as defined above, whereas carbocyclic ring B is substituted by groups R¹³-R¹⁷ as defined above.

As used herein, the term “fluoro-substituted” means that one or more, including all, of the hydrogens in the group have been replaced with fluorine.

The suffix “ene” added on to any of the above groups means that the group is divalent, i.e. inserted between two other groups.

A first aspect of the invention relates to a process for the production of hydrogen comprising contacting at least one complex of formula (I), with at least one substrate of formula (II) as defined above. Preferably, the process is carried out in the presence of a suitable solvent.

The invention consists of a catalyzed chemical process for the controlled and safe release of hydrogen at constant rate from the substrate ammonia borane or related organic N,B-substituted derivatives. The overall purpose of the process is to provide a constant flow rate of high purity hydrogen for use in fuel cells or combustion engines, which in combination with atmospheric oxygen emit only water. No external heating, light or electricity is required to initiate the catalytic dehydrogenation process. Hydrogen has been shown to carry an extremely energy to mass ratio of 120 MJ kg⁻¹ as compared to conventional gasoline products (44 MJ kg⁻¹).

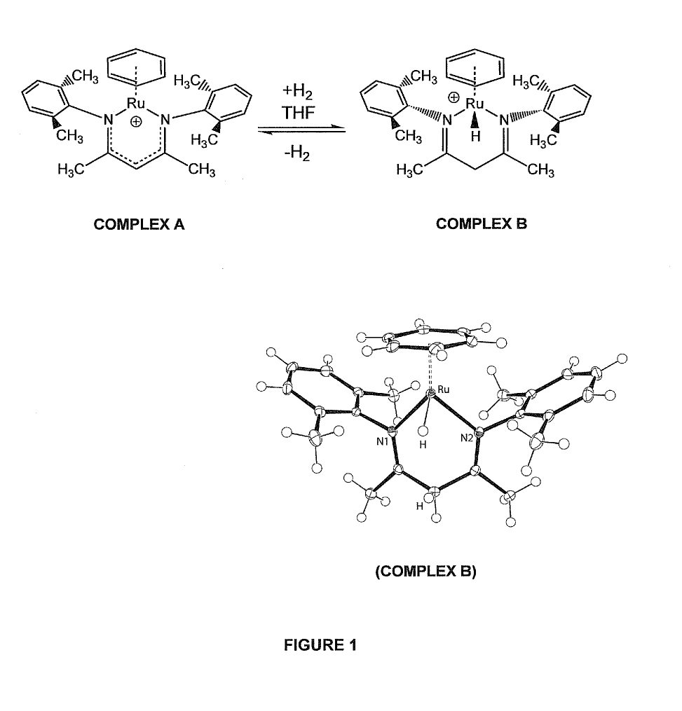

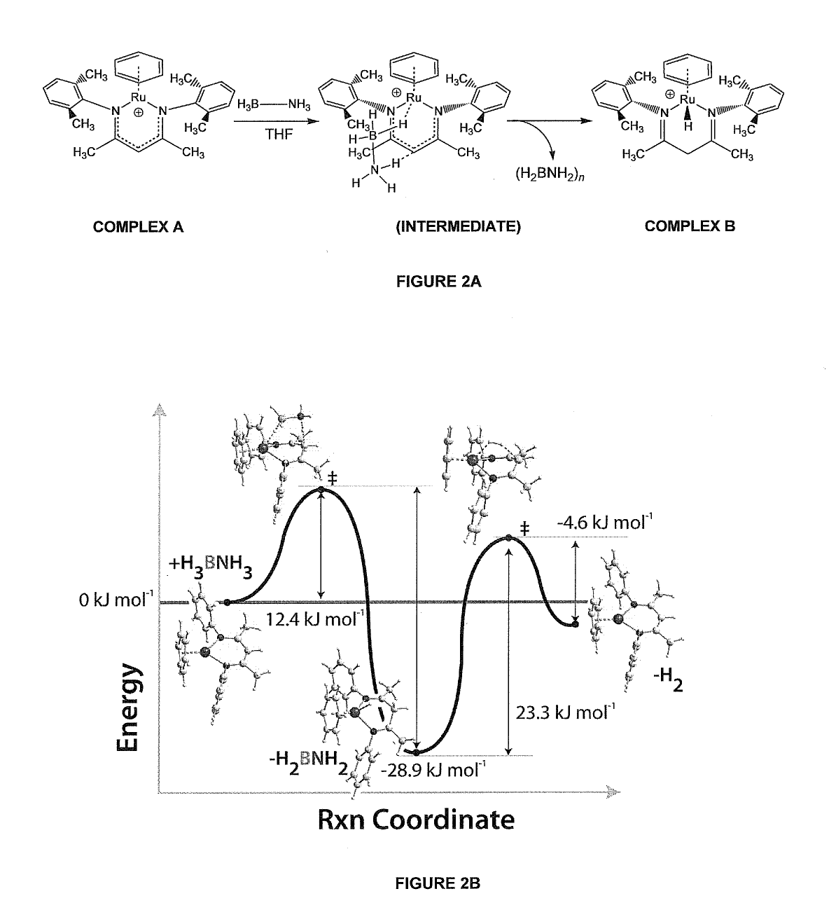

Advantageously, the presently described process provides a homogenous catalyst that activates gaseous dihydrogen. Ab initio calculations and experimental evidence have shown that a bifunctional mechanism is operative for the decoupling of ammonia borane. The reaction mechanism is illustrated in FIGS. 1 and 2. Specifically, the complex of formula (I) (e.g. denoted as complex A in FIGS. 1 and 2) extracts one equivalent of gaseous hydrogen from the substrate of formula (II) to form a hydride complex (e.g. denoted complex B in FIGS. 1 and 2). The resulting hydride complex is unstable and readily releases hydrogen at room temperature and pressure to reform the complex of formula (I) (e.g. complex A).

### Substrate of Formula (II)

The process of the invention uses a substrate of formula (II), R¹R²—NH—BH—R³R⁴, wherein R¹, R², R³ and R⁴ are each independently selected from H, C₁₋₂₀-alkyl, fluoro-substituted-C₁₋₂₀-alkyl, C₆₋₁₄-aryl and C₆₋₁₄-aralkyl or any two of R¹, R², R³ and R⁴ are linked to form a C₂₋₁₀-alkylene group, which together with the nitrogen and/or boron atoms to which they are attached, forms a cyclic group.

Preferably, R¹, R², R³ and R⁴ are each independently selected from H, fluoro-substituted-C₁₋₁₀-alkyl, C₆₋₁₀-aryl and C₆₋₁₀-aralkyl, or any two of R¹, R², R³ and R⁴ are linked to form a C₂₋₆-alkylene group, which together with the nitrogen and/or boron atoms to which they are attached, forms a cyclic group.

More preferably, R¹, R², R³ and R⁴ are each independently selected from H, fluoro-substituted-C₁₋₆-alkyl, C₆-aryl and C₆₋₁₀-aralkyl, or any two of R¹, R², R³ and R⁴ are linked to form a C₂₋₆-alkylene group, which together with the nitrogen and/or boron atoms to which they are attached, forms a cyclic group.

In one preferred embodiment, R³ and R⁴ are both H.

In one preferred embodiment, R³ and R⁴ are both H, and R¹ and R² are each independently selected from H, fluoro-substituted-C₁₋₁₀-alkyl, C₆₋₁₀-aryl and C₆₋₁₀-aralkyl, or R¹ and R² are linked to form a C₂₋₆-alkylene group, which together with the nitrogen atom to which they are attached, forms a cyclic group.

More preferably, R³ and R⁴ are both H and R¹, R² are each independently selected from H, fluoro-substituted-C₁₋₁₀-alkyl and C₆₋₁₀-aryl.

In one preferred embodiment of the invention, R¹, R², R³ and R⁴ are each independently selected from H and C₁₋₂₀-alkyl.

In one highly preferred embodiment, R³ and R⁴ are both H, one of R¹ and R² is H and the other is selected from H, C₁₋₁₀-fluoroalkyl, C₆₋₁₀-aryl and C₆₋₁₀-aralkyl.

More preferably, one of R¹ and R² is H and the other is selected from H, methyl, ethyl, isopropyl, n-propyl, isobutyl, n-butyl, tert-butyl, CF₃, sec-butyl, phenyl and benzyl.

In another highly preferred embodiment, R³ and R⁴ are both H, and R¹ and R² are each independently selected from H, methyl, ethyl, isopropyl, n-propyl, isobutyl, n-butyl, tert-butyl, sec-butyl, phenyl and benzyl, CF₃, or R¹ and R² are linked to form a C₂₋₆-alkylene group, which together with the nitrogen atom to which they are attached, forms a cyclic group. Preferably, where R¹ and R² are linked to form a C₂₋₆-alkylene group, the C₂₋₆-alkylene group is a C₄-alkylene group.

In one preferred embodiment, the substrate of formula (II) is selected from ammonia borane, methylamine borane, dimethylamine borane, di-isopropylamine borane, isopropylamine borane, tert-butylamine borane, isobutylamine borane, phenylamine borane and pyrrolidine borane.

In one especially preferred embodiment, the substrate of formula (II) is ammonia borane, H₃B—NH₃, i.e. R¹, R², R³ and R⁴ are all H. Ammonia borane is a non-combustible, industrially inexpensive, low molecular weight solid substrate that carries multiple molecular equivalents of hydrogen. Ammonia borane has a high hydrogen carrying capacity of 19.6% per weight and is not flammable. This is consistent with the objectives set forth by the American department of energy of 5.5 wt % in vehicles by 2015. Using a small amount (typically 1% mol) of a molecular catalyst (consisting of a metal and supporting organic ligands), decouples multiple equivalents of gaseous hydrogen from ammonia borane at a sustained rate at room temperature.

### Complex of Formula (I)

The process of the invention utilises a complex of formula (I), as defined above, as a catalyst. The catalyst is a bifunctional dual site complex consisting of a transition metal and a ligand that is robust and stable over long periods of time.

In one preferred embodiment, M is Ru.

In one highly preferred embodiment, the catalyst is a modified η⁶-arene β-diketiminato-ruthenium complex of formula (I), i.e. M is Ru. Advantageously, the catalyst can be synthesized in a single step process in high yield from commercially available precursors and can be stored in the solid state under nitrogen indefinitely.

As used herein, the complex of formula (I) is derived from a precursor that is a β-diketiminate-type ligand. Deprotonation of the structure shown on the left below (a β-diketimine type ligand) gives rise to a β-diketiminate-type ligand as shown on the right below, that is conventionally represented with the dashed lines showing a delocalisation of the negative charge. The negative charge may of course be further delocalised over the molecule, depending on the nature of the A and B rings.

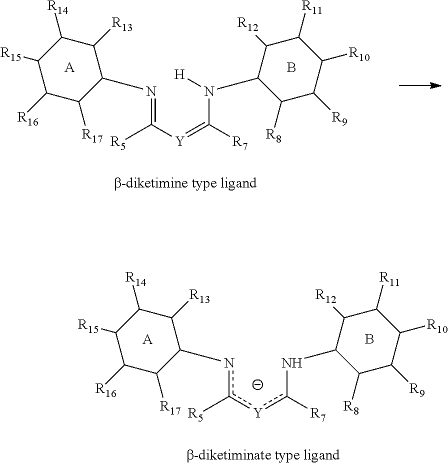

The β-diketiminate-type ligand is capable of forming a complex with Ru(II), OS(II) or Fe(II), for example, an η⁶-arene β-diketiminato-ruthenium complex, an η⁶-arene β-diketiminato-osmium complex or an η⁶-arene β-diketiminato-iron complex. Throughout the specification, the coordination between the metal M and the η⁶-arene group is represented as a dashed line.

In one preferred embodiment of the invention, counterion X⁻ in the complex of formula (I) is selected from OTf⁻, BF₄⁻, PF₆⁻, BPh₄⁻ and BArF⁻ (B((3,5-CF₃)₂C₆H₃)₄⁻). More preferably, counterion X⁻ is OTf⁻.

R⁵, R⁶ and R⁷ are each independently selected from H, NR²⁴R²⁵, C₁₋₆-alkyl and C₁₋₆-alkyl, or two or more of R⁵, R⁶ and R⁷ are linked, together with the carbons to which they are attached, to form a saturated or unsaturated carbocyclic group. Preferably, the C₁₋₆-haloalkyl group is a C₁₋₆-fluoroalkyl group.

Where R⁵, R⁶ and R⁷ are each independently NR²⁴R²⁵, preferably, R²⁴ and R²⁵ are each independently H or C₁₋₆-alkyl.

In one preferred embodiment of the invention, R⁵, R⁶ and R⁷ are each independently selected from H, NR²⁴R²⁵ and C₁₋₆-alkyl, or two or more of R⁵, R⁶ and R⁷ are linked, together with the carbons to which they are attached, to form a saturated or unsaturated carbocyclic group.

R⁸-R²⁵ are each independently selected from H, C₁₋₆-alkyl, C₁₋₆-haloalkyl and a linker group optionally attached to a solid support. Preferably, the C₁₋₆-haloalkyl group is a C₁₋₆-fluoroalkyl group.

In one preferred embodiment of the invention, R⁸-R²⁵ are each independently selected from H, C₁₋₆-alkyl and a linker group optionally attached to a solid support.

In one preferred embodiment of the invention, R⁸-R²⁵ are each independently selected from H, methyl, CF₃ and isopropyl and a linker group optionally attached to a solid support.

In another preferred embodiment of the invention, R⁸-R²⁵ are each independently selected from H, methyl, CF₃ and isopropyl.

In one preferred embodiment of the invention, R⁷ is selected from H, C₁₋₆-alkyl, C₁₋₆-haloalkyl, and R⁵ and R⁶ are linked together with the carbon atoms to which they are attached to form a 6-membered carbocyclic group. In one particularly preferred embodiment, the C₁₋₆-haloalkyl group is a C₁₋₆-fluoroalkyl group. More preferably, R⁵ and R⁶ are linked together with the carbon atoms to which they are attached to form a 6-membered unsaturated group.

In one preferred embodiment, Y is CR⁶.

In another preferred embodiment of the invention, Y is CR⁶, R⁶ is H and R⁵ and R⁷ are each independently selected from C₁₋₆-alkyl, C₁₋₆-haloalkyl and N(C₁₋₆-alkyl)₂. More preferably R⁵ and R⁷ are each independently selected from methyl, CF₃ and NMe₂.

In another preferred embodiment of the invention, Y is CR⁶, R⁶ is H and R⁵ and R⁷ are each independently selected from C₁₋₆-alkyl, and N(C₁₋₆-alkyl)₂. More preferably R⁵ and R⁷ are each independently selected from methyl and NMe₂

In one preferred embodiment, Y is N.

In one preferred embodiment, Y is N and R⁵ and R⁷ are each independently selected from C₁₋₆-alkyl, C₁₋₆-haloalkyl and N(C₁₋₆-alkyl)₂. More preferably R⁵ and R⁷ are each independently selected from methyl, CF₃ and NMe₂.

In one preferred embodiment, Y is N and R⁵ and R⁷ are each independently selected from C₁₋₆-alkyl and N(C₁₋₆-alkyl)₂. More preferably R⁵ and R⁷ are each independently selected from methyl and NMe₂.

In one preferred embodiment, R⁸, R¹², R¹³ and R¹⁷ are each independently selected from C₁₋₆-alkyl, C₁₋₆-haloalkyl, and R⁹, R¹⁰, R¹¹, R¹⁴R¹⁵ and R¹⁶ are all H.

In one preferred embodiment, R¹⁸-R²³ are each independently selected from H, C₁₋₆-alkyl, C₁₋₆-haloalkyl.

In one particularly preferred embodiment, R¹⁸-R²³ are all H.

In one particularly preferred embodiment, R¹⁸-R²³ are all each independently C₁₋₆-alkyl, more preferably, Me.

In one particularly preferred embodiment, R¹⁸ and R²¹ are C₁₋₆-alkyl, and R¹⁹, R²⁰, R²² and R²³ are all H.

In one particularly preferred embodiment, R¹⁸ is Me, R²¹ is isopropyl and R¹⁹, R²⁰, R²² and R²³ are all H.

In one particularly preferred embodiment, the complex of formula (I) is selected from the following:

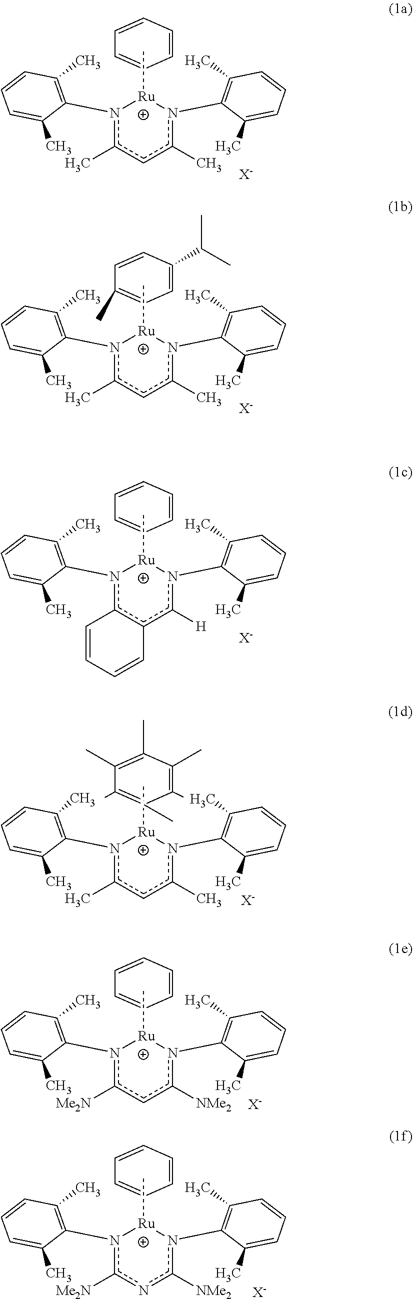

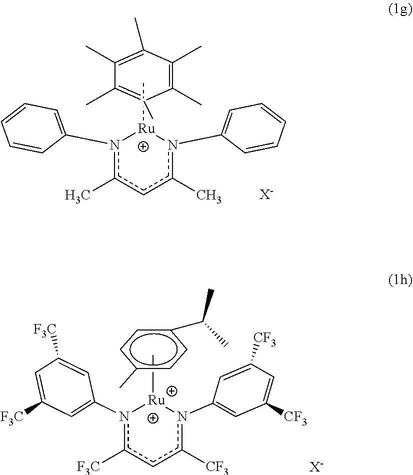

Even more preferably still, the complex of formula (I) is:

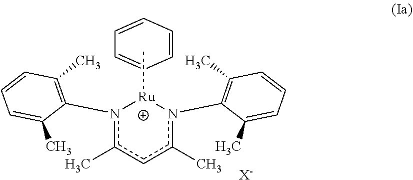

In one preferred embodiment, the complex of formula (I) is anchored to a solid support, for example, a polymer, thereby facilitating easy separation of the spent materials. Suitable solid supports will be familiar to one of ordinary skill in the art. Likewise, suitable linker groups for attaching the complex of formula (I) to the solid support will also be familiar to the skilled artisan.

The post-grafting of the catalyst to an insoluble solid surface is preferably achieved via attachment through the η⁶-arene, i.e. one or more of R¹⁸-R²³ is a linker group optionally attached to a solid support.

Preferably, the insoluble solid surface is mesoporous silica, e.g. MCM-41 containing hexagonal channels.

Preferably, the complex of formula (I) is anchored to the solid surface via a linear silanol alkyl tether.

The complex of formula (I) may be prepared and isolated prior to use in the process of the invention, or may be generated in situ.

Another aspect of the invention relates to a complex of formula (Ib), (Ic), (Id), (Ie), (If) (Ig) or (1h) as defined above.

### Process

The process of the reaction is typically carried out using a suitable solvent system. Preferably, the substrate of formula (II) is dissolved or slurried in a polar, non-protic solvent. Non-limiting examples of such solvents include toluene, chlorinated solvents such as methylene chloride and 1,2-dichlorobenzene, and ethereal solvents such as tetrahydrofuran (THF), 1,2-dimethoxyethane, diglyme and polyethylene glycol dimethyl ethylene. Such solvents may be used either individually or in combination with each other. Particularly preferred solvents include 1-butyl-3-methylimidazolium tetrafluoroborate, 1-ethyl-3-methylimidazolium trifluoromethanesulfonate, 1-butyl-3-methylimidazolium trifluoromethanesulfonate. Particularly preferred fluorinated solvents include α,α,α-trifluorotoluene.

Preferably, the process of the invention uses a non-volatile solvent, so that only dihydrogen is liberated during the reaction.

Preferably, the process of the invention takes place in a homogeneous mixture, i.e. preferably the complex of formula (I) is essentially soluble in the reaction solvent(s) and remains essentially in solution through the reaction process with minimal amounts of precipitation.

In one preferred embodiment, the solvent is a mixture of THF and dimethoxyethane. Preferably, the ratio of THF and dimethoxyethane is from about 4:1 to about 3:1.

Preferably, the complex of formula (I) is dissolved or slurried in solution with the same solvent as that used to dissolve or slurry the substrate of formula (II).

In one preferred embodiment, the process involves mixing a concentrated slurry of ammonia borane with an inert solvent mixed with a small amount of the η⁶-arene β-diketiminato-metal complex. The system remains inert until a flow valve is open and the catalytic process operates until the substrate is spent or the valve is closed. Studies showed that elevated temperatures did not significantly increase the static pressure of hydrogen.

The catalyst to substrate ratio directly controls the rate of hydrogen released. For example, 0.5 mol % of the catalyst dissolved in solution (THF, dimethoxyethane) will release one substrate equivalent of hydrogen within 60 seconds. This is comparable to yielding from 1 g of H₃BNH₃, a sustained rate of 779 cm³ of H₂ per min at 1 atm pressure or 13 cc per second.

The catalyst is capable of extracting up to two equivalents of hydrogen from the ammonia borane substrate. The activity of the catalyst is controlled by hydrogen pressure and liberates hydrogen from ammonia borane until a pressure of 3 atm is obtained. At pressures over 3 atm, the catalyst is deactivated, but is re-activated upon pressure release. Thus, the system dramatically reduces the amount of free hydrogen within the system during static storage periods. Compared to gas-liquid hydrogen storage, powering a gasoline equivalent automobile, a 235 L H2 tank weighting 64 kg with 340 atm of pressure is required to be fixed onboard. In comparison, the invention does not require a pressurized container; the material construction of the cell can consist of light weight plastics. In comparison, the weight of the ammonia borane cell would be about 50 kg, but with a significantly more compacted volume of 65 L.

Preferably, the process of the invention is carried out at reduced pressure.

Advantageously, the process can be carried out without the need for an external heat source. Preferably, the process of the invention is carried out at a temperature of at least 0° C.

The hydrogen that is generated in the process of the invention may be optionally captured using any known means. The reaction produces, in addition to hydrogen gas, easily recyclable and environmentally friendly ammonium borate salts as the only detectable boron-containing residue. The reaction may be performed in air, but may also be performed in an inert atmosphere, for example, under argon or neon, or under hydrogen.

Preferably, the process of the invention is carried out in the absence of oxygen.

Preferably, the process of the invention is carried out in an inert atmosphere.

### Hydrogen Generation System

There are expected to be many applications for the process of the present disclosure. In one embodiment, the process of the invention is used to generate hydrogen, which is supplied to a hydrogen fuel cell, such as a PEMFC. Hydrogen generators may include a first compartment holding a catalyst-comprising solution and a second compartment holding the one or more substrates of formula (II) as defined above.

A further aspect of the invention therefore relates to a hydrogen generation system comprising:

(a) at least one complex of formula (I)

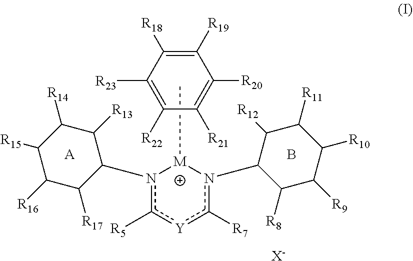

wherein:
X⁻ is an anion;

### Y is N or CR⁶

M is selected from Ru, Os and Fe;
each of A and B is independently a saturated, unsaturated or partially unsaturated carbocyclic ring;
R⁵, R⁶ and R⁷ are each independently selected from H, NR²⁴R²⁵, C₁₋₆-alkyl and C₁₋₆-haloalkyl, or two or more of R⁵, R⁶ and R⁷ are linked, together with the carbons to which they are attached, to form a saturated or unsaturated carbocyclic group;
R⁸-R²⁵ are each independently selected from H, C₁₋₆-haloalkyl and a linker group optionally attached to a solid support;
(b) at least one substrate of formula (II),

R¹R²—NH—BH—R³R⁴ (II)

wherein R¹, R², R³ and R⁴ are each independently selected from H, fluoro-substituted-C₁₋₂₀-alkyl and C₆₋₁₄-aryl, or any two of R¹, R², R³ and R⁴ are linked to form a C₂₋₁₀-alkylene group, which together with the nitrogen and/or boron atoms to which they are attached, forms a cyclic group; and
(c) a solvent.

In one preferred embodiment of the invention, the hydrogen generation system comprises a first compartment comprising the at least one complex of formula (I), a second compartment comprising the at least one substrate of formula (II), wherein the first or second compartment further comprises a solvent and/or a means for combining the contents of the first compartment with the contents of the second compartment such that when the contents are combined, hydrogen is generated.

More preferably, the hydrogen generation system further comprises at least one flow controller to control a flow rate of the at least one complex of formula (I) or the at least one substrate of formula (II).

Preferably, control electronics are coupled to catalyst mass flow controllers and hydrogen mass flow controllers. Catalyst mass flow controllers control the flow of the catalyst solution, which enters second compartment to achieve a desired hydrogen flow generated by the hydrogen generator.

In one preferred embodiment, the at least one substrate of formula (II) is stored in a second compartment as a solid or as a solution in the solvent. In operation, as soon as the hydrogen generator is turned on, control electronics send a signal to a mass flow controller (or a flow controller) to allow a predetermined flow rate of the at least one complex of formula (I) in a solvolytic and/or hydrolytic solvent in a first compartment to flow into the second compartment which holds the substrate of formula (II). As a result, hydrogen gas in generated. The reaction by-products are captured and remain in the second compartment. In alternate embodiments the substrate of formula (II) can be provided in the first compartment and be pumped into the second compartment holding the complex of formula (I) in the solvent.

The hydrogen generation system is preferably in the form of a self-contained reaction vessel that is attached via a vent to any application requiring a source of hydrogen gas, for example, a chemical reaction, a fuel cell, or the like. Suitable fuel cells will be familiar to one skilled in the art and include any fuel cells that can use hydrogen as a fuel source, for example, internal combustion engines (ICE), solid oxide fuel cells (SOFC), phosphoric acid fuel cells (PAFC), alkaline fuel cells (AFC) and molten carbonate fuel cells (MCFC).

In one particularly preferred embodiment of the invention, the hydrogen generation system is connected to a proton exchange membrane fuel cell (PEMFC). More preferably, a coupling connector delivers hydrogen generated by hydrogen generator to the anode of a PEMFC.

The hydrogen generators disclosed herein are capable of delivering PEMFC grade hydrogen at low reaction temperatures, safely and reliably. Such hydrogen PEM fuel cells are optimal for applications where batteries and internal combustion engines do not deliver cost-effective and convenient power generation solutions. Advantageously, the hydrogen generators disclosed herein provide a constant source of power in a compact size that does not require electrical recharging.

Another aspect of the invention relates to the use of at least one complex of formula (I) as defined above in a fuel cell.

Another aspect of the invention relates to a fuel cell comprising at least one complex of formula (I) as defined above. Preferably, the fuel cell further comprises a substrate of formula (II) as defined above, and optionally a suitable solvent.

Another aspect of the invention relates to a method of thermolytically dehydrogenating a substrate of formula (II) as described above, said method comprising contacting at least one substrate of formula (II) with a complex of formula (I) in the presence of a solvent.

Another aspect of the invention relates to the use of at least one complex of formula (I) as defined above in a method of thermolytically dehydrogenating a substrate of formula (II) as described above.

Another aspect of the invention relates to the use of at least one complex of formula (I) as defined above in a method of producing hydrogen. Preferably, the complex of formula (I) is used in conjunction with a substrate of formula (II) as defined above.

Another aspect of the invention relates to a method of using a hydrogen generation system as defined above which comprises modulating the hydrogen pressure in said system so as to modulate activity of the at least one complex of formula (I).

The present invention is further illustrated by way of the following non-limiting examples, and with reference to the following Figures, wherein:

FIG. 1 shows the schematic relationship between complex A and complex B, together with the structure of complex B.

FIG. 2A shows the schematic reaction between complex A and H₃B—NH₃ to form complex B. FIG. 2B shows the corresponding energy profile.

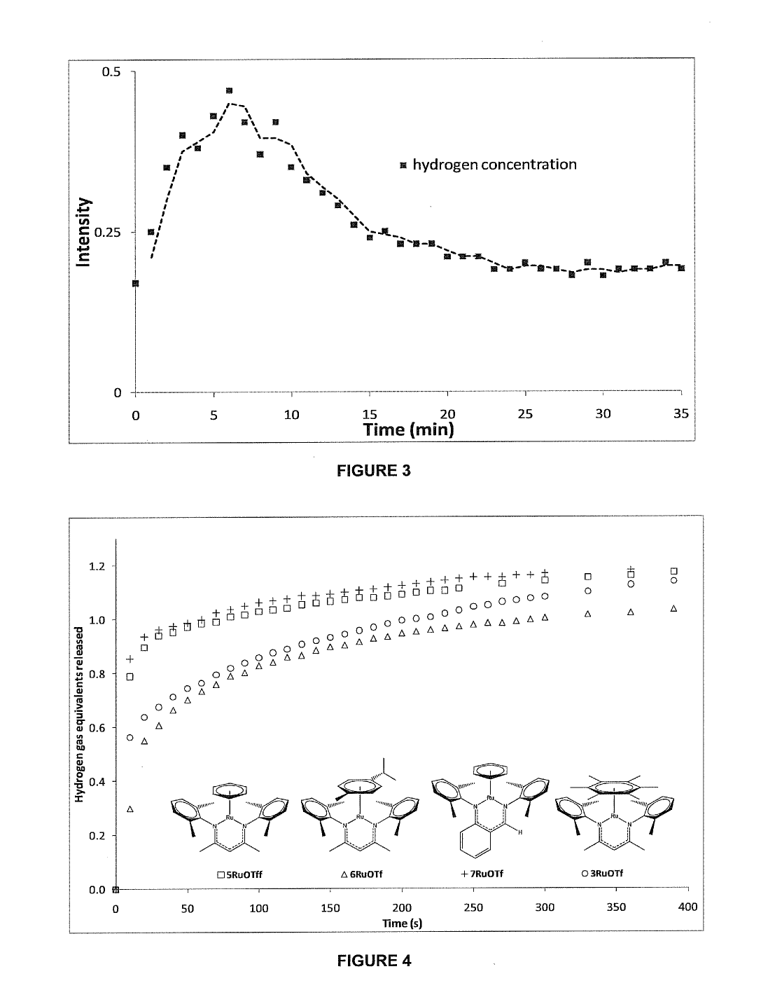

FIG. 3 shows the results of an NMR study of hydrogen release (intensity versus time (min)).

FIG. 4 shows the results of a volume flow study (hydrogen equivalents released versus time (s)). Two catalyst types liberate 1.0 equivalent of hydrogen from ammonia borane.

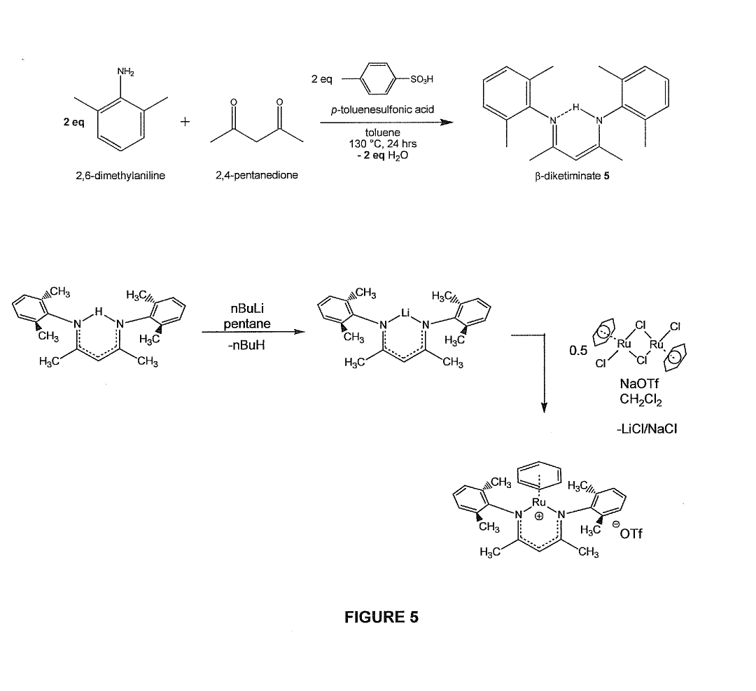

FIG. 5 shows the synthetic route for preparing a catalyst according to the invention.

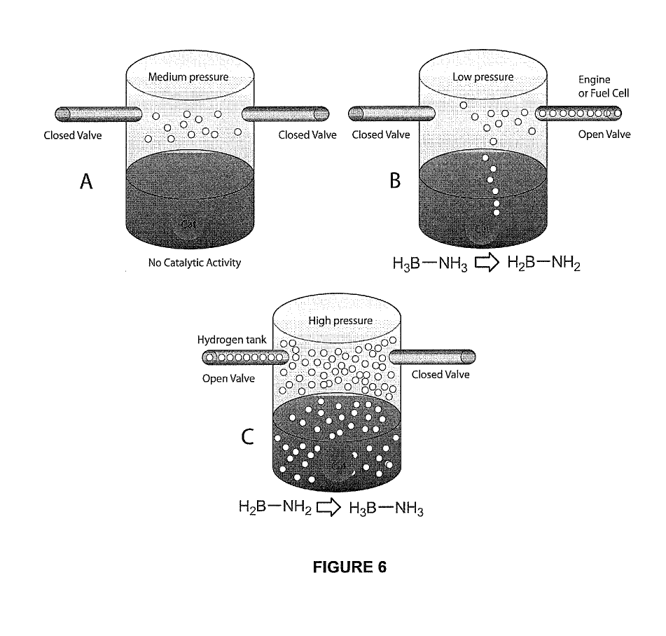

FIG. 6 shows an idealized onboard regenerative system based on ammonia borane. The concept is broken down as follows: (a) the reactor is loaded with the active complex solubilised in medium which is not volatile, or with vapour pressure that is low. The reactor is next filled with an ammonia borane or similar hydrogen containing substrate. The reaction is initiated and H₂ is released according to the cycle shown in FIG. 6. This process occurs until the H₂ pressure reaches about 3-10 bar depending on the catalyst used; (b) when the valve of the reactor is opened, the drop in H₂ pressure will reinitiate the reaction until all of the substrate, in this case H₃B—NH₃, is spent; (c) to regenerate the substrate, the reactor is connected to high pressure H₂ source and at an evaluated temperature, the process is reversed and the product is hydrogenated back to the H₂-carrying substrate, H₃B—NH₃.

### EXAMPLES

### Example 1

### Preparation of Catalyst

The synthesis is straightforward and implements cheap starting materials. The catalyst is made in a single pot procedure (see FIG. 5). Advantageously, the complex of the invention uses non-toxic ruthenium metal which is significantly cheaper than Ir or Rh.

### General Procedures

The synthesis of the starting materials and the catalysts was carried out under a purified N₂ atmosphere with standard Schlenk techniques, whereas subsequent synthesis and manipulations of all products and reagents were performed in a dry box with a N₂ atmosphere containing less 1 ppm of O₂ and H₂O and equipped with a vacuum outlet. All glassware was pre-dried and the flasks underwent several purge/refill cycles before the introduction of solvents or reagents. All solvents were dried according to literature procedures involving distillation over the appropriate drying agents ¹ and then stored in Schlenk flasks equipped with teflon stopcocks. Celite powder for filtration was kept in an oven at 130° C. prior to use. All other reagents and gases (technical grade) were purchased from commercial sources and used as received if not specified differently. NMR spectra were recorded using either a Varian 300, 400 or 500 MHz instruments. If necessary, ¹H (COSY, NOE), ¹³C (HMBC and HSQC) one- and two-dimensional spectra were used to assign molecular connectivity and conformation in solution. Deuterated dichloromethane was distilled over CaH₂ and stored over 4 Å molecular sieves. Anhydrous THF-d₈ was purchased in sealed ampoules from Apollo Scientific and used as received. Chemical shifts for ¹H, ¹³C, ¹⁹F, and ¹¹B spectra were referenced to Me₄Si or to the appropriate deuterated solvent. ESI mass spectra were recorded using a Micromass Quattro micro instrument.

The synthesis of the bis(dichloro(η⁶-arene)ruthenium(II)) dimers was carried out by a modified procedure according to Bennett et al. [M. Bennet, A. Smith, J. Chem. Soc., Dalton 1974, 233].

### N,N′-Bis(2,6-dimethylphenyl)-2,4-pentanediimine

The procedure is based on the synthesis reported by Feldman et al. [J. Feldman, Organometallics 1997, 16, 1514-1516]. To a 500 ml round bottom flask equipped with a large magnetic stir bar, 4.00 g (0.04 mol) of 2,4-pentanedione (Acros Organics), and 15.20 g (0.08 mol, 2 eq) of p-toluenesulfonic acid monohydrate (Acros Organics) were added and combined with 9.68 g (0.08 mol, 2 eq) of 2,6-dimethylaniline (Acros Organics). 175 ml of toluene were added to the reaction mixture. The round bottom flask was equipped with a Dean-Stark reflux condenser to allow for collection of water. The mixture was allowed to reflux at 130° C. over night. The yellow solution was reduced in volume and stored at −20° C. over night, after which an off-white solid formed. The solid was filtered off and added to 200 ml of distilled water and 100 ml of concentrated Na₂CO₃ (80 g) in a large 500 ml beaker. After stirring the solution for about 1 hour, the two phases were separated. The aqueous solution was extracted twice with 70 ml of dichloromethane. The combined organic phases were dried over MgSO₄ and filtered. The filtrate was reduced in volume until a dark yellow oil is formed. Methanol was carefully added on top of the oil and the product was left to crystallize at −20° C. The white crystalline product was washed with cold methanol and dried under vacuum to afford 8.5 g (70%) of the N,N′-bis(2,6-dimethylphenyl)-2,4-pentanediimine.

¹H NMR (25° C., 300 MHz, CDCl₃) δ(ppm): 12.16 (s, 1H, N—HN), 7.03 (d, J=7.4 Hz, 4H, Ar m-CH), 6.94 (dd, J=8.4, 6.4 Hz, 2H, Ar p-CH), 4.88 (s, 1H, β-CH), 2.16 (s, 12H, o-CH₃), 1.69 (s, 6H, α-CH₃). ¹³C NMR (25° C., 101 MHz, CDCl₃) δ(ppm): 160.94 (s, C═N), 143.92 (s, Ar o-C), 132.27 (s, Ar i-C), 127.93 (s, Ar m-CH), 124.45 (s, Ar p-CH), 93.59 (s, β-CH), 20.50 (s, α-CH₃), 18.54 (s, o-CH₃).

### Lithium N,N′-Bis(2,6-dimethylphenyl)-2,4-pentanediketiminate

10 ml (0.016 mol) of a 1.6 M ⁿBuLi solution (Acros Organics) were added drop wise to 4.67 g (15.2 mmol) of N,N′-bis(2,6-dimethylphenyl)-2,4-pentanediimine in 80 ml of dried and degassed pentane under nitrogen at −20° C. The solution was left stirring under nitrogen at −20° C. for 1 hour. Once the formation of a white precipitate was observed, the solvent was reduced under vacuum to ¾ of its initial volume. The solution was transferred to a Schlenk tube containing a glass sintered filter by canulae. The white filtrate was washed with pentane under nitrogen and dried under vacuum to yield 4.5 g (95%) of Li(N,N′-bis(2,6-dimethylphenyl)-2,4-pentanediketiminate).

¹H NMR (25° C., 300 MHz, C₆D₆) δ(ppm): 7.14-6.93 (m, 6H, Ar m/p-CH), 4.77 (s, 1H, β-CH), 2.03 (s, 12H, o-CH₃), 1.65 (s, 6H, α-CH₃).

### Ortho-C₆H₄F(CH═NC₈H₉)

The synthesis was adapted from Hayes et al. [Hayes, P. G.; Welch, G. C.; Emslie, D. J. H.; Noack, C. L.; Piers, W. E.; Parvez, M., A New Chelating Anilido-Imine Donor Related to beta-Diketiminato Ligands for Stabilization of Organoyttrium Cations. Organometallics 2003, 22 (8), 1577-1579]. 11.5 g (92.8 mmol) of o-fluorobenzaldehyde and 12.4 g (102 mmol, 1.1 eq) of 2,6-dimethylaniline were dissolved in 40 ml of pentane and let stir for 2 hours. MgSO₄ was added and the mixture was filtered and reduced in volume. The crude product was filtered over a short column of silica using pentane. The solvent was removed under vacuum to afford ortho-C₆H₄F(CH═NC₈H₉) as a bright yellow oil (78%).

¹H NMR (25° C., 300 MHz, CDCl₃) δ(ppm): 8.54 (s, 1H, α-H), 8.24 (td, J=7.6, 1.8 Hz, 1H, α,β-Ph-H), 7.47 (qd, J=7.3, 1.8 Hz, 1H, α,β-Ph-H), 7.26 (t, J=7.6 Hz, 1H, α,β-Ph-H), 7.13 (m, 1H, α,β-Ph-H), 7.07 (m, 3H, Ar m/p-CH), 6.95 (dd, J=8.3, 6.8 Hz, 1H, α,β-Ph-H), 2.15 (s, 6H, o-CH). ¹⁹F NMR (25° C., 282 MHz, CDCl₃) δ(ppm): −121.67 (m, 1F, Ar—F).

### Ortho-C₆H₄[NH(C₈H₉)](CH═NC₈H₉)

69 ml (0.11 mol, 1.1 eq) of a 1.6 M solution of nBuLi in hexane was added to a cooled solution of 12.8 g (0.1 mol) 2,6-dimethylaniline in 40 ml of dried and degassed THF under nitrogen at −78° C. The reaction was stirred at −78° C. for 5 hours and then slowly allowed to warm to room temperature at which it was stirred for another 8 hours. A solution of 21 g (0.092 mol) of ortho-C₆H₄F(CH═NC₈H₉) in dried and degassed THF (10 ml) was added to the LiNH(2,6-dimethylphenyl) solution under nitrogen. The reaction mixture was stirred for 4 hours at room temperature to afford a dark red-orange solution. 20 ml of water are slowly added to the reaction an. The organic phase was extracted with pentane and dried over MgSO₄. The solvent was removed in vacuo and the crude product was recrystallised from boiling methanol to afford 14.74 g (49%) of the title compound as a light yellow solid.

¹H NMR (25° C., 400 MHz, CDCl₃) δ(ppm): 10.52 (s, 1H, N—HN), 8.37 (s, 1H, α,β-Ph-H), 7.33 (dd, J=7.7, 1.5 Hz, 1H, α,β-Ph-H), 7.20-7.04 (m, 6H, Ar m/p-CH), 7.00-6.93 (m, 1H, α,β-Ph-H), 6.71 (td, J=7.6, 1.0 Hz, 1H, α,β-Ph-H), 6.28 (d, J=8.4 Hz, 1H, α,β-Ph-H), 2.24 (s, 6H, o-CH), 2.19 (s, 6H, o-CH′). ¹³C NMR (25° C., 101 MHz, CDCl₃) δ(ppm): 166.14 (CH═NPh), 150.98 (α,β-Ph-C—N), 148.66, 137.68, 136.95, 134.74, 132.40 (α,β-Ph-C), 128.56, 128.30, 127.85, 126.57, 123.99, 116.90, 115.54, 111.95 (Ar C), 18.73 (Ar—CH₃), 18.59 (Ar—CH₃′). Anal. found [Calcd] C, 83.91 [84.10], H, 7.18 [7.37], N, 8.46 [8.53].

The η⁶-arene-ruthenium(II)-η²-diketiminato trifluoromethanesulfonate complexes were synthesised according to Phillips et al. [Organometallics 2007, 26, 1120-1122]

### (η⁶-Benzene)-ruthenium(II)-η²-N,N′-bis(2,6-dimethylphenyl)-2,4-pentanediketiminato trifluoromethanesulfonate

234 mg (0.75 mmol) of lithium N,N′-bis(2,6-dimethylphenyl)-2,4-pentanediketiminate were added to a 50 ml Schlenk tube under inert conditions and dissolved in 20 ml of dried and degassed dichloromethane. 187 mg (0.375 mmol) of [(η⁶-C₆H₆)RuCl]₂Cl₂ and 142 mg (0.825 mmol) of sodium trifluoromethanesulfonate were added to a second 50 ml Schlenk tube. The solution containing the diketiminate ligand was transferred to the solid sodium trifluoromethanesulfonate bis(dichloro(η⁶-benzene)ruthenium(II)) mixture by canula. The reaction was allowed to stir for 24 hours under nitrogen at room temperature. The solution was filtered over celite under nitrogen to remove sodium chloride. Dichloromethane was removed from the filtrate under vacuum and the crude product was washed several times with degassed pentane and decanted. After drying the brown-red solid under vacuum for 3 days, 380 mg (80%) of the title compound were obtained.

¹H NMR (300 MHz, 25° C., CD₂CD₂) δ(ppm) 7.46-7.26 (m, 6H, Ar m/p-CH), 6.64 (s, 1H, β-CH), 5.17 (s, 6H, Bz Ar CH), 2.16 (s, 6H, α-CH₃), 2.15 (s, 12H, o-CH₃). ¹³C NMR (25° C., 100.6 MHz, CD₂Cl₂), δ(ppm): 19.08 (s, Ar o-CH₃), 23.28 (s, α-CH₃), 84.13 (s, Bz CH), 105.57 (s, β-CH), 121.43 (q, ¹J_{CF}=322 Hz, SO₃CF₃⁻), 128.03 (s, Ar p-CH), 129.56 (s, Ar m-CH), 129.98 (s, Ar o-C), 158.69 (s, Ar i-C), 163.92 (s, CNAr). ¹⁹F NMR (25° C., 188.2 MHz, CD₂Cl₂), δ(ppm): −79.2 (s, ¹J_{FC}=322 Hz, CF₃SO₃⁻). Anal. found [Calcd] C, 52.66 [52.98], H, 4.85 [4.78], N, 4.11 [4.30].

### (η⁶-Hexamethylbenzene)-ruthenium(II)-η²-N,N′-bis(2,6-dimethylphenyl)-2,4-pentanediketiminato trifluoromethanesulfonate

The synthesis was performed similar to the one for (η⁶-benzene)-ruthenium(II)-η²-N,N′-bis(2,6-dimethylphenyl)-2,4-pentanediketiminato trifluoromethanesulfonate, which yielded 353 mg (66%) of (η⁶-hexamethylbenzene)-ruthenium(II)-η²-N,N′-bis(2,6-dimethylphenyl)-2,4-pentanediketiminato trifluoromethanesulfonate as a brown-red solid.

¹H NMR (25° C., 300 MHz, CD₂Cl₂) δ(ppm): 7.42 (m, 4H, Ar m-CH), 7.37-7.24 (m, 2H, Ar p-CH), 6.39 (s, 1H, β-CH), 2.07 (s; 12H, o-CH₃), 1.94 (s, 6H, α-CH₃), 1.52 (s, 18H, Ar-Me₆).

¹³C NMR (25° C., 101 MHz, CD₂Cl₂) δ(ppm): 163.20 (CNAr), 155.99 (Ar i-C), 130.42 (Ar m-CH), 127.63 (Ar p-CH), 121.43 (q, ¹J_{CF}=322 Hz, SO₃CF₃), 103.82 (β-CH), 24.58 (α-CH₃), 19.25 (Ar o-CH₃), 16.23 (C₆Me₆). ¹⁹F NMR (25° C., 282 MHz, CD₂Cl₂) δ(ppm): −78.88 (s, 1F, OTf-CF₃). Anal. found [Calcd] C, 57.32 [56.81], H, 6.38 [6.03], N, 3.74 [3.90].

### (η⁶-p-Cymene)-ruthenium(II)-η²-N,N′-Bis(2,6-dimethylphenyl)-2,4-pentanediketiminato trifluoromethanesulfonate

Following the above procedure for (η⁶-benzene)-ruthenium(II)-η²-N,N′-Bis(2,6-dimethylphenyl)-2,4-pentanediketiminato trifluoromethanesulfonate, (η⁶-p-cymene)-ruthenium(II)-η²-N,N′-bis(2,6-dimethylphenyl)-2,4-pentanediketiminato trifluoromethanesulfonate was obtained as a dark red-brown solid (81%).

¹H NMR (25° C., 300 MHz, CD₂CD₂) δ(ppm): 7.48-7.25 (m, 6H, Ar m/p-CH), 6.55 (s, 1H, β-CH), 4.79 (d, J=6.6 Hz, 2H, pCym Ar CH′), 4.41 (d, J=6.6 Hz, 2H, pCym Ar CH), 2.50 (hept, J=6.9 Hz, 1H, pCym iPr—CH), 2.18 (s, 6H, α-CH₃), 2.15 (s, 12H, o-CH₃), 1.90 (s, 3H, pCym CH₃), 1.15 (d, J=6.9 Hz, 6H, pCym iPr—CH₃). ¹³C NMR (25° C., 101 MHz, CD₂Cl₂) δ(ppm): 164.12 (CNAr), 158.48 (Ar i-C), 130.04 (?), 129.46 (Ar m-CH), 127.87 (Ar p-CH), 104.78 (β-CH), 104.25 (pCym-CMe₂), 92.98 (pCym-CMe), 87.33 (pCym-CH), 84.12 (pCym-CH), 32.70 (iPr—CMe₂), 23.59 (iPr—CMe₂), 23.31 (α-CH₃), 19.08 (o-CH₃). ¹⁹F NMR (25° C., 282 MHz, CD₂CD₂) δ(ppm); −78.87 (s, 3F, OTf-CF₃).

### [(η⁶-benzene)-ruthenium(II)-η²-(ortho-C₆H₄[N(C₈H₉)](CH═NC₈H₉))]OTf

To a solution of 600 mg (1.8 mmol) of Ortho-C₆H₄[NH(C₈H₉)](CH═NC₈H₉) in 10 ml of dried and degassed toluene, 1.3 ml (21 mmol) of a 1.6 M ⁿ BuLi solution in hexanes was added at −78° C. under nitrogen. The reaction was stirred for a day at room temperature under nitrogen, and the solvent was removed in vacuo.

In a second step, the crude solid was dissolved in dried and degassed dichloromethane and transferred into a 50 ml Schlenk flask containing 457 mg (0.9 mmol) of bis(dichloro(η⁶-benzene)ruthenium(II)) and 409 mg (2.4 mmol) of sodium trifluoromethanesulfonate. The reaction was stirred at room temperature under an atmosphere of nitrogen for 48 hours to afford a black-purple solution. The mixture was filtered under nitrogen over celite to remove solid lithium chloride. Dichloromethane was removed from the filtrate in vacuo and the crude solid was washed with dried and degassed diethyl ether to afford 640 mg (56%) of the title compound as a dark red solid.

¹H NMR (25° C., 300 MHz, CD₂Cl₂) δ(ppm): 8.76 (s, 1H, α-H), 7.74 (dd, J=8.0, 1.7 Hz, 1H, α,β-Ph-H), 7.69-7.62 (m, 1H, α,β-Ph-H), 7.50-7.34 (m, 6H, Ar m/p-CH), 7.18 (d, J=8.8 Hz, 1H, α,β-Ph-H), 5.27 (s, 6H, Ar Bz CH), 2.22 (s, 6H, o-CH), 2.10 (s, 6H, o-CH′). ¹³C NMR (25° C., 101 MHz, CD₂Cl₂) δ(ppm): 164.07 (CHN), 158.65 (i-CN), 158.26 (i-C′N), 149.84 (α,β-Ph-CN), 136.70 (α,β-Ph-CH), 136.40 (α,β-Ph-CH), 130.69 (Ar p-CH), 129.69 (Ar p-C′H), 129.09 (Ar m-CH), 128.93 (Ar m-C′H), 128.28 (Ar o-CMe), 127.58 (Ar o-C′Me), 123.24 (α,β-Ph-CH), 121.43 (q, ¹J_{CF}=322 Hz, SO₃CF₃), 115.33 (α,β-Ph-C), 113.41 (α,β-Ph-CH), 84.44 (Bz Ar—CH), 18.29 (o-CH₃), 17.91 (o-C′H₃). ¹⁹F NMR (25° C., 282 MHz, CD₂Cl₂) δ(ppm): −78.54 (s, 3F, OTf-CF₃).

Compound (Ia), with a range of different anions was prepared in accordance with the procedures described in Organometallics 2009, 28, 6432-6441.

### Example 2

### Protocol for Ammonia-Borane Dehydrocoupling

In a 50 ml Schlenk tube, 20 mg (0.65 mmol) of H₃NBH₃ were dissolved in 2 ml of dried and degassed THF under inert conditions. 0.0065 mmol (1 mol %) of [(η⁶⁻arene)-ruthenium(II)-diketiminato]OTf catalyst were added in a second 50 ml Schlenk tube under inert conditions. The solution containing ammonia-borane was added to the catalyst by syringe. Hydrogen gas evolution was measured by connecting a water-gas burette to the reaction flask.

### Example 3

### Volume Flow Study

Studies showed that two catalyst types liberate 1.0 equivalent of H₂ from ammonia borane (see FIG. 4).

### Example 4

### NMR Study of Dihydrogen Release

FIG. 3 shows the results of an NMR study of dihydrogen release (intensity versus time (min)). Importantly, complex A enables a rapid release of H₂ from ammonia borane, then a slow down when the solvent is saturated with H₂ due to pressure build up. Thus, complex A is deactivated at high pressure, but reactivated at low pressure, which is an important safety feature.

Various modifications and variations of the described aspects of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes of carrying out the invention which are obvious to those skilled in the relevant fields are intended to be within the scope of the following claims.

1. A process for the production of hydrogen comprising contacting at least one complex of formula (I), 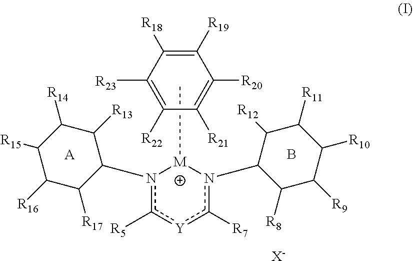
wherein:
X⁻ is an anion;
Y is N or CR⁶;
M is selected from Ru, Os and Fe;
each of A and B is independently a saturated, unsaturated or partially unsaturated carbocyclic ring;
R⁵, R⁶ and R⁷ are each independently selected from H, NR²⁴R²⁵, C₁₋₆-alkyl and C₁₋₆-haloalkyl, or two or more of R⁵, R⁶ and R⁷ are linked, together with the carbons to which they are attached, to form a saturated or unsaturated carbocyclic group;
R⁸-R²⁵ are each independently selected from H, C₁₋₆-alkyl, C₁₋₆-haloalkyl and a linker group optionally attached to a solid support;
with at least one substrate of formula (II),
R¹R²—NH—BH—R³R⁴ (II)
wherein R¹, R², R³ and R⁴ are each independently selected from H, C₁₋₂₀-alkyl, fluoro-substituted-C₁₋₂₀-alkyl, C₆₋₁₄-aryl and C₆₋₁₄-aralkyl, or any two of R¹, R², R³ and R⁴ are linked to form a C₂₋₁₀-alkylene group, which together with the nitrogen and/or boron atoms to which they are attached, forms a cyclic group.

2. A process according to claim 1 wherein R³ and R⁴ are both H, one of R¹ and R² is H and the other is selected from H, CF₃, methyl, ethyl, isopropyl, n-propyl, isobutyl, n-butyl, tert-butyl, sec-butyl, phenyl and benzyl.

3. A process according to claim 1 wherein R³ and R⁴ are both H, and R¹ and R² are each independently selected from H, CF₃, methyl, ethyl, isopropyl, n-propyl, isobutyl, n-butyl, tert-butyl, sec-butyl, phenyl and benzyl, or R¹ and R² are linked to form a C₄-alkylene group, which together with the nitrogen atom to which they are attached, forms a cyclic group.

4. A process according to claim 1 wherein the substrate of formula (II) is selected from ammonia borane, methylamine borane, dimethylamine borane, di-isopropylamine borane, isopropylamine borane, tert-butylamine borane, isobutylamine borane, phenylamine borane and pyrrolidine borane, and mixtures thereof.

5. A process according to claim 1 wherein the substrate of formula (II) is ammonia borane (H₃B—NH₃).

6. A process according to claim 1 wherein X⁻ is selected from OTf⁻, BF₄⁻, PF₆⁻, BPh₄⁻ or BArF⁻ (B((3,5-CF₃)₂O₆H₃)₄⁻), more preferably, OTf⁻.

7. A process according to claim 1 wherein M is Ru.

8. A process according to claim 1 wherein R⁸-R²³ are each independently selected from H, methyl, CF₃ and isopropyl.

9. A process according to claim 1 wherein R⁷ is selected from H, O₁₋₆-alkyl and C₁₋₆-haloalkyl, and R⁵ and R⁶ are linked together with the carbon atoms to which they are attached to form a 6-membered carbocyclic group.

10. A process according to claim 1 wherein R⁶ is H and R⁵ and R⁷ are each independently selected from C₁₋₆-alkyl and C₁₋₆-haloalkyl, more preferably R⁵ and R⁷ are each independently selected from methyl and CF₃.

11. A process according to claim 1 wherein the compound of formula (I) is selected from the following:

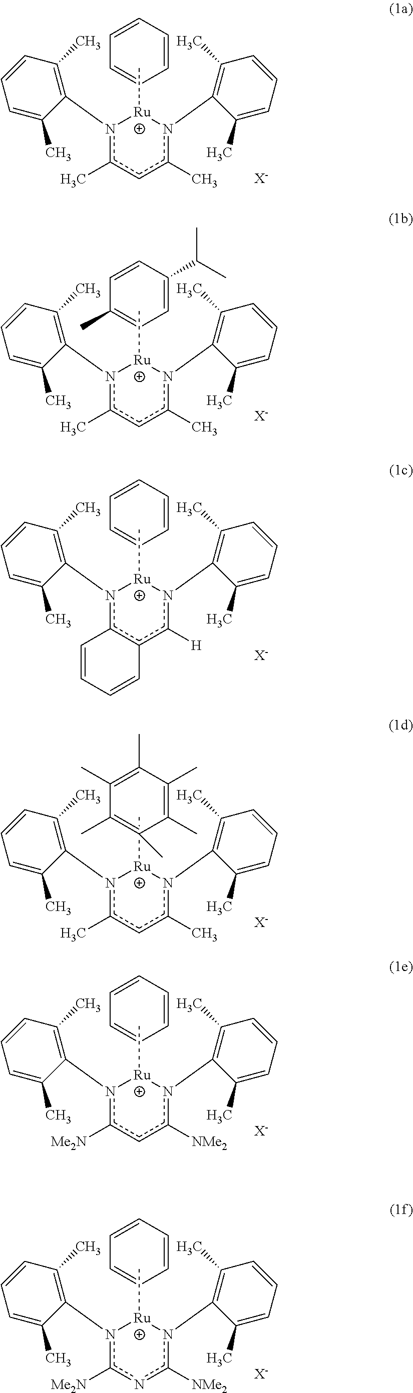

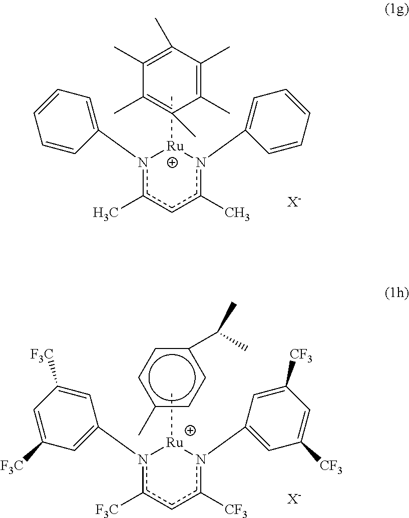

12. (canceled)

13. A hydrogen generation system comprising:
(a) at least one complex of formula (I) 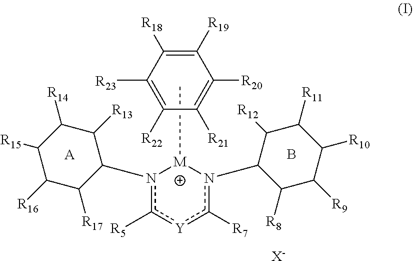
wherein:
X⁻ is an anion;
Y is N or CR⁶;
M is selected from Ru, Os and Fe;
each of A and B is independently a saturated, unsaturated or partially unsaturated carbocyclic ring;
R⁵, R⁶ and R⁷ are each independently selected from H, NR²⁴R²⁵, C₁₋₆-alkyl, C₁₋₆-haloalkyl, or two or more of R⁵, R⁶ and R⁷ are linked, together with the carbons to which they are attached, to form a saturated or unsaturated carbocyclic group;
R⁸-R²⁵ are each independently selected from H, C₁₋₆-alkyl, C₁₋₆-haloalkyl and a linker group optionally attached to a solid support;
(b) at least one substrate of formula (II),
R¹R²—NH—BH—R³R⁴ (II)
wherein R¹, R², R³ and R⁴ are each independently selected from H, C₁₋₂₀-alkyl, fluoro-substituted-C₁₋₂₀-alkyl and C₆₋₁₄-aryl, or any two of R¹, R², R³ and R⁴ are linked to form a C₂₋₁₀-alkylene group, which together with the nitrogen and/or boron atoms to which they are attached, forms a cyclic group; and
(c) a solvent.

14-15. (canceled)

16. A hydrogen generation system according to claim 1 wherein said system is connected to a proton exchange membrane fuel cell (PEMFC), or any other system requiring a supply of hydrogen.

17. Use of at least one complex of formula (I) as defined in claim 1 in a fuel cell.

18. A fuel cell comprising at least one complex of formula (I) as defined in claim 1.

19. A method of thermolytically dehydrogenating a substrate of formula (II) as defined in claim 1, said method comprising contacting at least one substrate of formula (II) as defined in claim 1 with a complex of formula (I) in the presence of a solvent.

20. Use of at least one complex of formula (I) as defined in claim 1 in a method of thermolytically dehydrogenating a substrate of formula (II) as defined in claim 1.

21. Use of at least one complex of formula (I) as defined in claim 1 in a method of producing hydrogen.

22. A complex of formula (Ib), (Ic), (Id), (Ie), (If), (Ig) or (Ih),

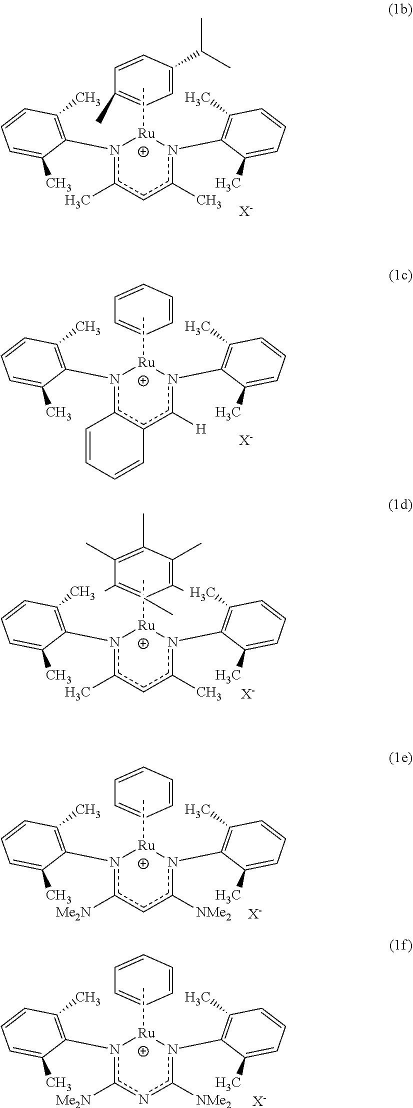

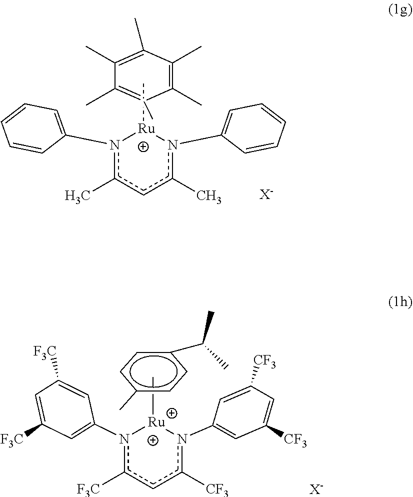

23. A method of using a hydrogen generation system according to claim 1 which comprises modulating the hydrogen pressure in said system so as to modulate activity of the at least one complex of formula (I).

24. (canceled)
